(19) United States
(12) Patent Application Publication
(10) Pub. No.: US 2014/0222347 A1
(43) Pub. Date: Aug. 7, 2014

(54) Seismic Waveform Classification System And Method

(71) Applicant: Drilling Info, Inc., Austin, TX (US)

(72) Inventor: William M. Bashore, Littleton, CO (US)

(73) Assignee: Drilling Info, Inc., Austin, TX (US)

(21) Appl. No.: 14/071,558

(22) Filed: Nov. 4, 2013

Related U.S. Application Data
(60) Provisional application No. 61/722,147, filed on Nov. 3, 2012.

(51) Int. Cl. G01V 1/28

(52) U.S. Cl. CPC G01V 1/282
USPC 702/16

(57) ABSTRACT

A system and method for classifying seismic waveforms are provided. The system and method may be used to assist an analyst to rapidly and accurately identify commonalities and inter-relationships, which may be related to similar geologic conditions, within a collection of seismic waveform traces.

### PRIORITY CLAIM/RELATED APPLICATION

This application claims the benefit of and priority to, under 35 USC 119(e) and 120, U.S. Provisional Patent Application Ser. No. 61/722,147 filed on Nov. 3, 2012 and titled Seismic Waveform Classification Systems and Methods”, the entirety of which is incorporated herein by reference.

### FIELD

This disclosure relates to a process for classifying seismic data into common waveform responses. An analysis window within the seismic data may be of constant time or depth duration or variable as defined by one or two interpreted horizons. This disclosure is particularly applicable to 3D seismic data volumes and to 2D seismic lines, and by natural extension, to microseismic events.

### BACKGROUND

Geologic modeling is known. The accurate modeling of a subsurface domain, such as a reservoir under investigation for possible petroleum or oil and gas content, or in more general terms a geologic basin, is critical to the ongoing investigation of that domain. Drilling exploratory wells is an expensive undertaking, as is a full-scale seismic or magnetic survey, and accurate decision-making requires accurate geological mapping.

Information about the geologic horizons present in such a reservoir is clearly an important first step. Knowledge of the type and thickness of sedimentary strata provides a geologist with key information for visualizing the subsurface structure. In most areas, however, strata are cut with numerous faults, making the analytical task considerably more complicated. Geologic mapping requires that the faults be identified and that the amount of the slippage along the fault plane be quantified. The amount of slippage, or “throw”, can range from little to no actual movement in the case of a fracture, to a distance of hundreds of kilometers along a major fault zone such as the San Andreas Fault of California.

A three dimensional (“3-D”) model of a geologic domain would be a highly useful tool for geologists and exploration planning managers. That technology lies at the intersection between geology, geophysics, and 3-D computer graphics, and several inherent problems need to be overcome in such a product. First, data are often incomplete. The volumes in question range from the earth's surface down many thousands of feet, and data are generally difficult to obtain. Moreover, for the data that are available, often in the nature of seismic survey results and well log data, are subject to considerable processing and interpretation. Second, a large measure of professional judgment goes into the rendering of any such analysis, so that the goal of any analytical tool cannot be a complete result, but rather should be aimed at assisting the geologist to bring her judgment to bear in the most of efficient and effective manner possible.

A further difficulty stems from the inherent complexity of the problem. A typical petroleum reservoir, for example, may consist of many lithology variations, various diagenic overprints, and complicated fault and fracture regimes. Understanding the presence, mechanics, and distributions of the reservoir characterisitics is vital to optimizing the discovery, development, and ultimate hydrocarbon extraction.

Reflection seismic methods have long been used to image the geologic structure and stratigraphy of the earth. This is particularly true in the exploration for and development of hydrocarbon bearing strata. Differences in seismic signatures are functions of differences in geologic character. Interpretation of spatial patterns of similar and varying seismic waveforms may lead to interpretation of the associated geologic spatial variations, which, in turn, may lead to better exploration and development.

Many seismic waveform classification techniques are known, in which the classification waveforms are derived through complex statistical processes, which may be intuitively obscure and computationally expensive. The results of these techniques are often highly starting condition dependent, causing different results for different starting points, and the global variability in waveform responses may not be sampled or modeled. Also, the results may be heavily dependent upon the choice of statistical modeling algorithm.

### BRIEF DESCRIPTION OF THE DRAWINGS

FIG. 1 is an image of the example 3D seismic volume illustrating a prism of the associated seismic traces;

FIG. 2 is an image of an interpreted horizon used to define an analysis portion of the seismic volume shown in FIG. 1;

FIG. 3 is an image of the analysis portion of the volume shown in FIG. 1;

FIG. 4 is a graphical display plotting the decrease in Cluster Separation Index as the number of classification waveforms in the solution increases;

FIG. 5 is a graphical display illustrating a resulting 20 classification waveforms sorted by similarity;

FIG. 6 is a graphical display illustrating a resulting 20 classification waveforms sorted by significance;

FIGS. 7A and 7B show a solution map for two different number of classification waveforms based upon significance;

FIGS. 8A and 8B show a solution map on the left that was generated by selecting eleven classification waveforms sorted by similarity and a solution map on the right that has twenty classifications and provides increased gradational detail within the channel complex;

FIG. 9 illustrates a method of classifying waveforms;

FIG. 10 illustrates a method of selecting a most similar waveform out of a subset of all of the waveforms;

FIG. 11 illustrates a method for classifying remaining subset of waveforms that are not the most similar waveform; and

FIGS. 12A and 12B are block diagrams of two different computing environment/computer systems that may be used to implement a seismic waveform classification system.

### DETAILED DESCRIPTION OF ONE OR MORE EMBODIMENTS

The system and method are described below with respect to a waveform classification system for prospecting and subsequent development of oil and gas reserves and may be used as a tool by geoscientists and engineers in the prospecting and subsequent development of oil and gas reserves. However, the system and method has broader application since the system and method can be used in other near surface seismic imaging (e.g., ground penetrating radar use in civil engineering and archeology), to categorize microseismic events associated with hydraulic fracturing and the like and it is understood that the disclosure covers each of the applications of the system and method. The system may also be applied to microseismic data, often collected in association with hydraulic fracturing process in oil and gas development. Classifying microseismic event signatures may be useful in understanding spatial clustering of similar events and, further, to modeling source mechanisms. Understanding source mechanisms are helpful in interpreting fracture orientation and stress states.

An aspect of the disclosure involves a system and method for classifying seismic waveform to assist an analyst to rapidly and accurately identify commonalities and inter-relationships, which may be related to similar geologic conditions, within a collection of seismic waveform traces. The seismic waveforms correspond to, for example, seismic traces. A seismic trace is a time series curve recorded at a location on the earth's surface. The time series curve corresponds to echoes of sound or elastic waves from geological features in the subsurface. Investigating the spatial nature of these waveform commonalities and relationships is important for understanding geologic complexities.

Implementations of the present disclosure involve a system and/or method for classifying waveforms. More specifically, the disclosure describes a seismic waveform classification system (SWCS) directed to extraction and delineation of areal trends in seismic response. These trends may be directly correlated with geologic trends that may be related to a variety of investigative earth studies. Identification and interpretation of these trends is a common activity of geoscientists and engineers in the prospecting and subsequent development of oil and gas reserves, although the system and method can also be used in other near surface seismic imaging (e.g., ground penetrating radar use in civil engineering and archeology) or it may also be used to categorize microseismic events associated with hydraulic fracturing.

According to one aspect, the SWCS analyzes a large number of seismic traces collected at a particular location at the earth's surface and extracts the greatest diversity of waveform responses directly from the seismic traces as the final or starting classification waveforms. Because of this direct extraction of greatest diversity, the subset of traces for analysis may often only need to be one percent or less of the total number of traces. No choice of complicated or obscure statistical algorithm is needed. Additional conditioning without overly modifying the waveforms can be done. Further, the classification waveforms may then be ordered in terms of overall significance and of gradational similarity. Finally, because only the first classification waveform requires an exhaustive search of the sample subset of traces and because all subsequent classification waveforms are compared only to the previously derived waveforms, the system is computationally fast which permits implementation on a computer in a highly interactive and interpretive design.

The system and method allows for improved mapping of seismic waveform commonalities and inter-relationships using a straightforward, easily explained approach (i.e., no in-depth mathematical or statistical knowledge is required to understand the method). It ensures sampling of the greatest diversity of waveform responses with information on waveform hierarchy in terms of significance and similarity. Additionally, it is fast enough to be implemented in highly interactive and interpretive computer software.

This system may directly sample waveforms from seismic traces based upon the following scheme: 1) find the waveform that has a highest aggregate similarity to all traces in the set; 2) iteratively find the remaining desired number of waveforms from the trace set as those which are least similar to the previously identified; 3) optionally condition the waveforms found in steps 1 and 2 using a statistical “training” method such as self-organizing maps; 4) order the waveforms based on significance and similarity for interpretive purposes; and 5) compare the final classification waveforms to each seismic trace and assign the index of the one with the highest similarity to that location, producing a final classification map.

The system is configured to iteratively determining a set of waveforms that optimally represent the variability within the overall set of waveforms. That is, this set of waveforms are inherently as dissimilar to each other while collectively being as similar as possible to full set of waveforms. Once these representative waveforms have been determined, they may be optionally conditioned by the full set of waveforms. These final “classification waveforms” are then ordered according to similarity to each other and overall significance to the full set of waveforms.

The initial classification waveforms may be determined directly from the subset of seismic traces. The first classification waveform is the trace waveform that is most similar to all other trace waveforms in the subset. Thereafter, the additional classification waveforms are dependent upon the previously determined classification waveforms. That is, the next classification waveform is the trace waveform least similar (most dissimilar) to the ones already determine. The second is the least similar trace waveform to the first one found, the third is the least similar to the first two, the fourth least similar to the first three, and so on. This ensures that the initial classification waveforms (presuming the additional training step) represent the most common seismic waveform response and then most varied responses after that. Also, there is an extreme efficiency in increasing the number of classification waveforms as comparisons are only made between the number of traces in the subset and the number of previously generated classification waveforms without compromising maximum diversity in the determined waveforms.

Unlike other conventional approaches, two sets of ordering are easily obtained. The use of a separation index permits an ordering based upon significance. This permits interpretation of the number of classifications necessary to explain seismic waveform variability while minimizing redundancy (as indicated by slope changes in the index vs number of classifications plot). A second ordering based on similarity gradation may be simultaneously computed with the separation index. As the significance order is computed, a second list may be kept where the next significant classification waveform is inserted according to maximum similarity to adjacent classifications. Plotting the solution maps by similarity sorting permits interpretation of the granularity of detail desired to explain appropriate geologic detail.

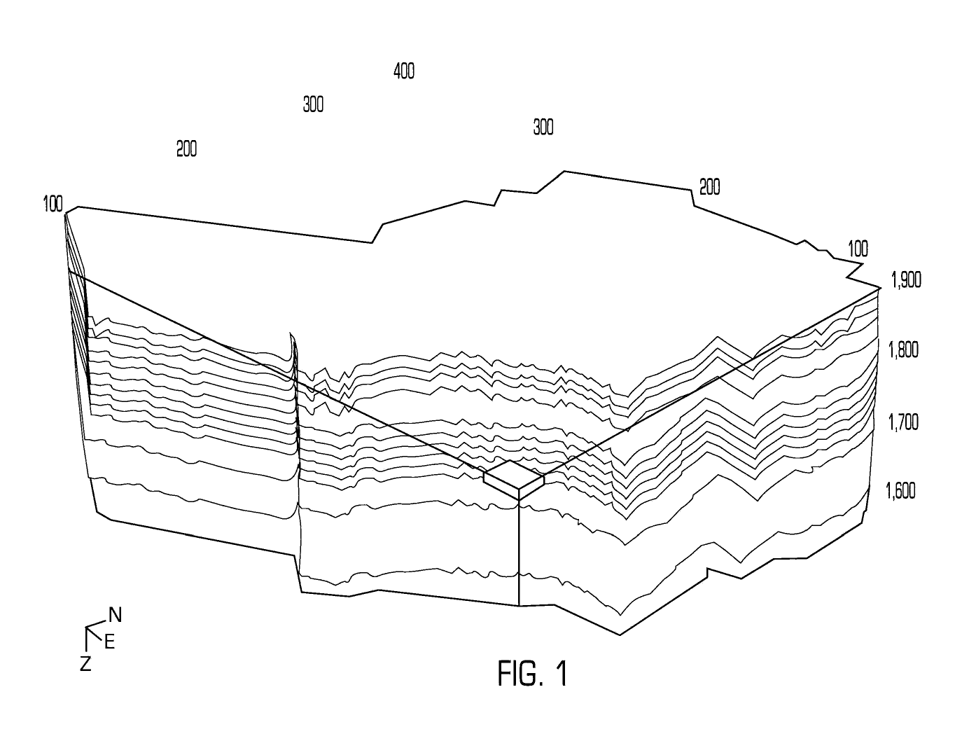

The workflow illustrated in the FIGS. 1-8B used to illustrates an example implementation of the system comes from a 3D seismic survey acquired on the onshore US Gulf Coast region. The exploration objective was fluvial-channel sand reservoirs known to contain hydrocarbons. The general channel trends are expected to be oriented from NE to SW. The seismic waveform response of the channel complex is expected to be different than the seismic waveform of the non-channel regions. Further delineation of geologic complexity within the channel complex resulting in seismic waveform variations could prove quite useful.

An example seismic volume is shown in FIG. 1. It contains 52,775 active traces. FIG. 1 is an image of the example 3D seismic volume illustrating an inline, a crossline and a constant time slice. The portion of the volume shown contains 367 inlines, 288 crosslines, and 500 milliseconds at 2 millisecond sampling. Not all inline and crossline locations have valid seismic traces.

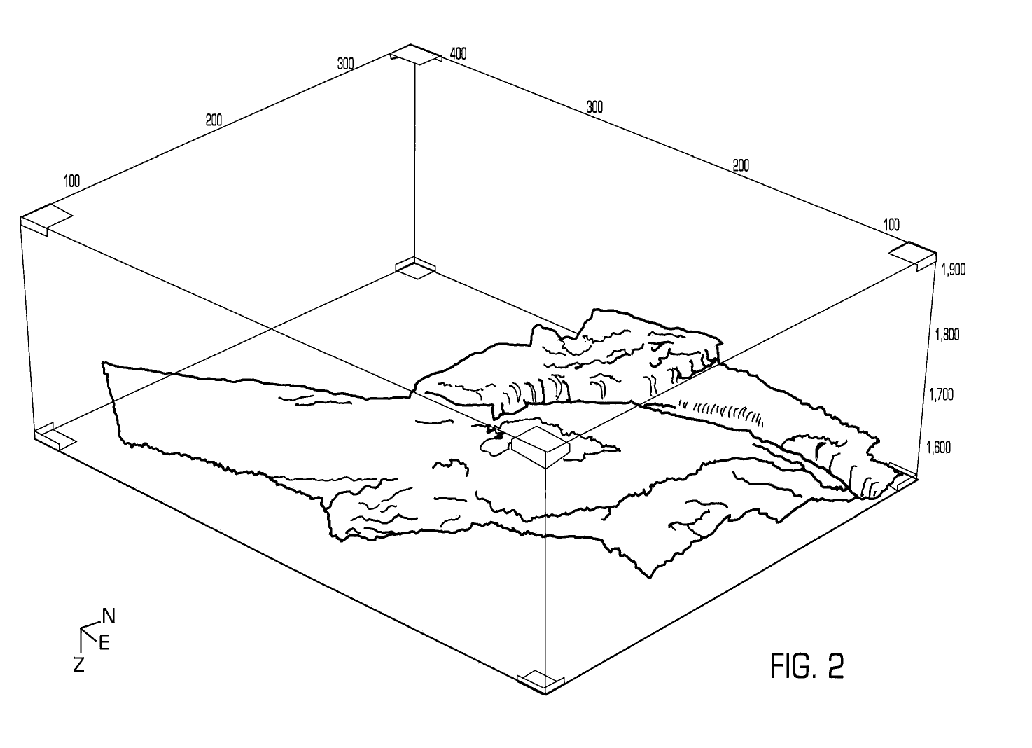

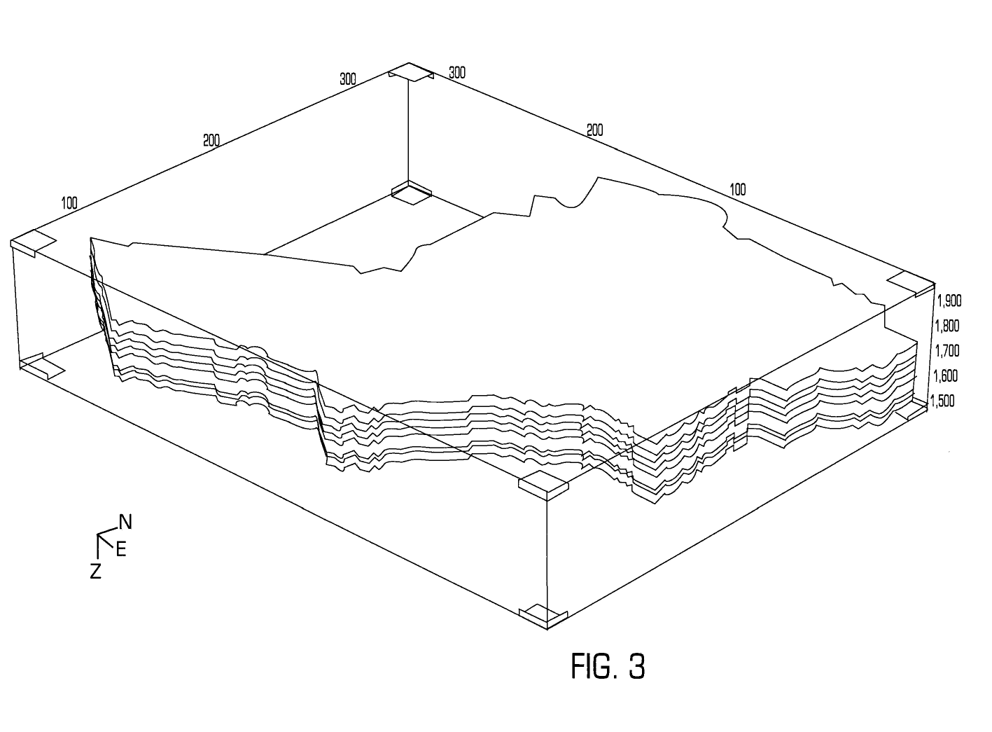

FIG. 2 is an image of the interpreted horizon used to define the analysis portion of the seismic volume, such as an analysis window 50 milliseconds above and below the horizon, shown in FIG. 1. The outline of the volume is shown for reference to the position of the horizon within the volume. The horizon was picked on a prominent negative peak in the seismic waveforms and is expected to be near a known fluvial channel complex. The resulting windowed volume is shown in FIG. 3 which is defined by 50 milliseconds above and below the interpreted horizon shown in FIG. 2.

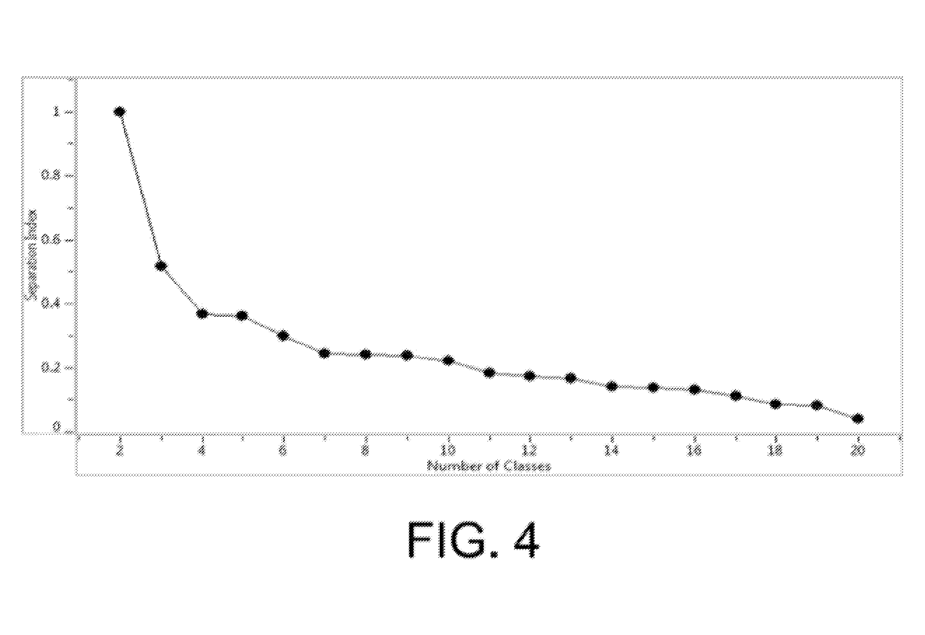

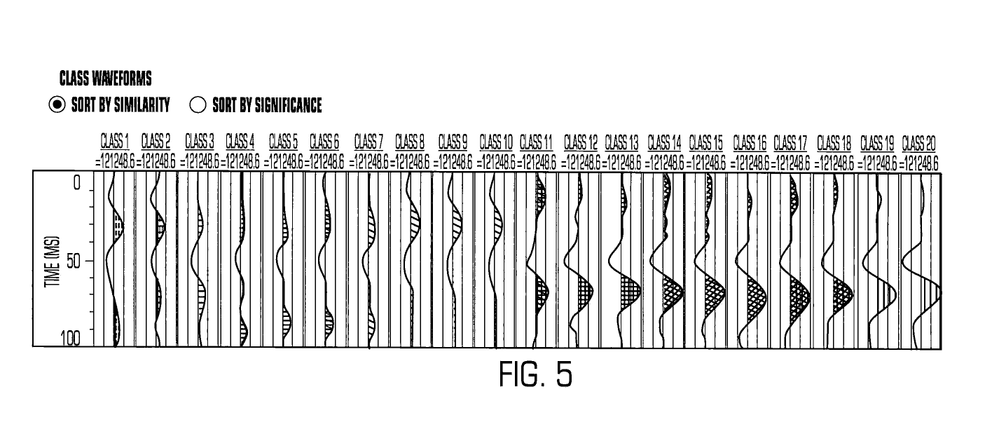

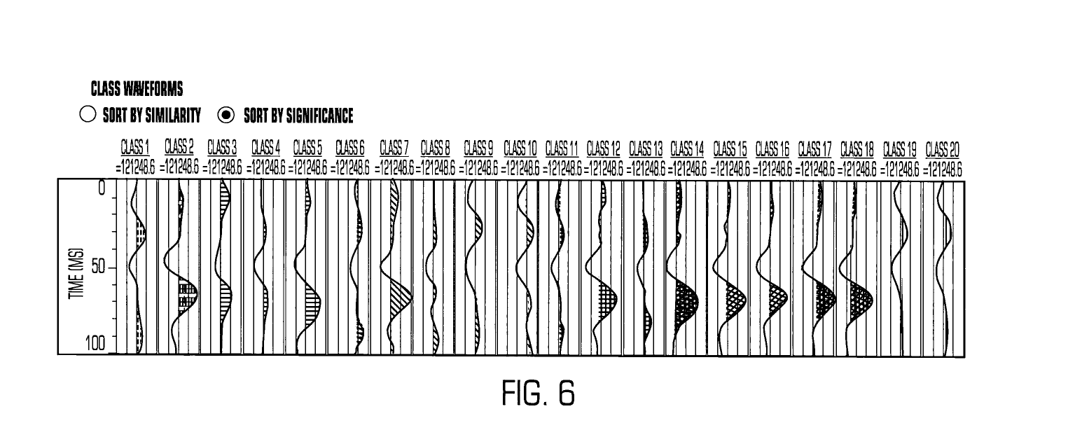

A subset of 528 traces from a 10×10 coarse grid was used for the analysis. The resulting CSI versus waveform index is shown in FIG. 4, with the resulting waveforms plotted by similarity and significance in FIGS. 5 and 6, respectively. FIG. 4 is a graphical display plotting the decrease in Cluster Separation Index as the number of classification waveforms in the solution increases. Abrupt changes in this decrease as seen between 4 and 5, 7 and 8, 11 and 12, and at 20 are useful in determining the number of useful waveforms. FIG. 5 is a graphical display illustrating the resulting 20 classification waveforms sorted by similarity. It can easily be seen the two end waveforms are quite distinct from one another and that there is a gradual change across the spectrum of waveforms. FIG. 6 is a graphical display illustrating the resulting 20 classification waveforms sorted by significance. It can easily be seen the left four waveforms are quite distinct from each other. This was suggested in the Cluster Separation Index plot of FIG. 4.

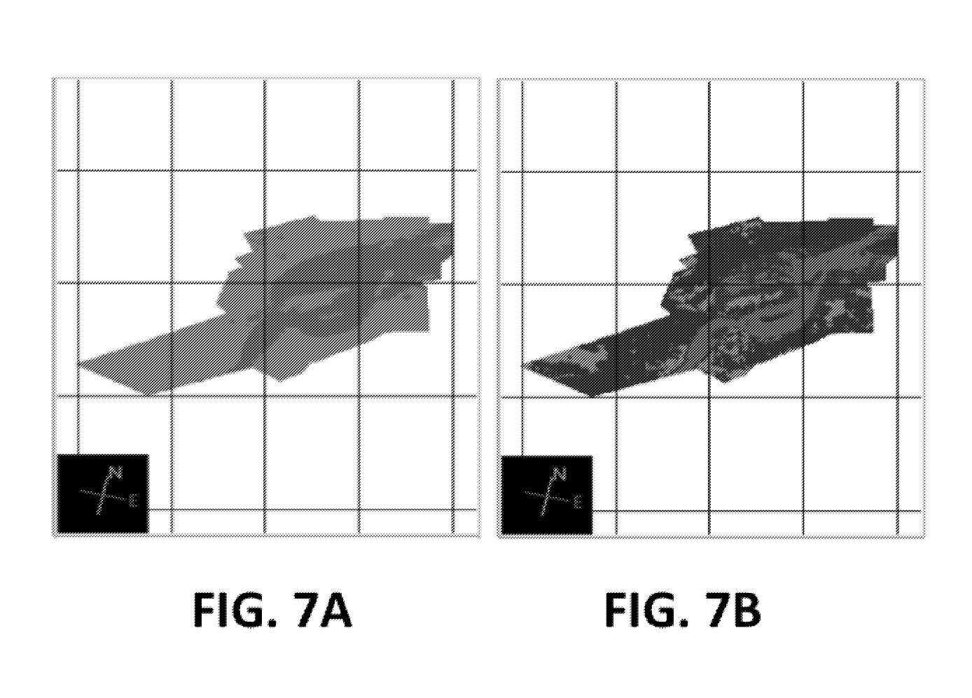

Solution maps based on selecting the two and four most significant waveforms are shown in FIGS. 7A and 7B. FIGS. 7A and 7B shows solution maps for two different number of classification waveforms based upon significance. The left map in FIG. 7A shows the seismic trace locations more similar to either the most significant classification waveform (light purple) or to the next most significant classification waveform (darker purple). It is interesting to note that only two waveforms are sufficient to capture the trend nature of the channel complex (darker purple) from the non-channel part (lighter purple). Increasing the number of significant classification waveforms to four begins to increase the detail in the non-channel portion and in the channel complex.

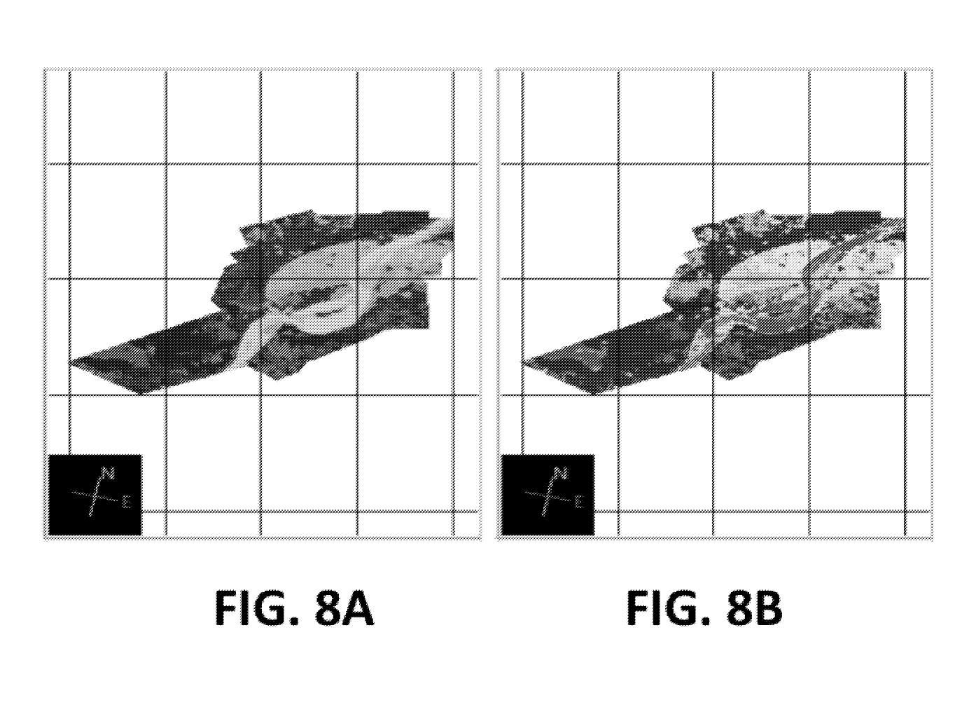

Solution maps based on selecting eleven and twenty waveforms are shown in FIGS. 8A and 8B. The solution map on the left (FIG. 8A) was generated by selecting eleven classification waveforms sorted by similarity. There is a gradation of color from light purple to blue to green. The channel complex is nicely detailed with the lightest green classification potentially being the best location for sand development. If further detail is desired, the right solution map has twenty classifications and provides increased gradational detail within the channel complex.

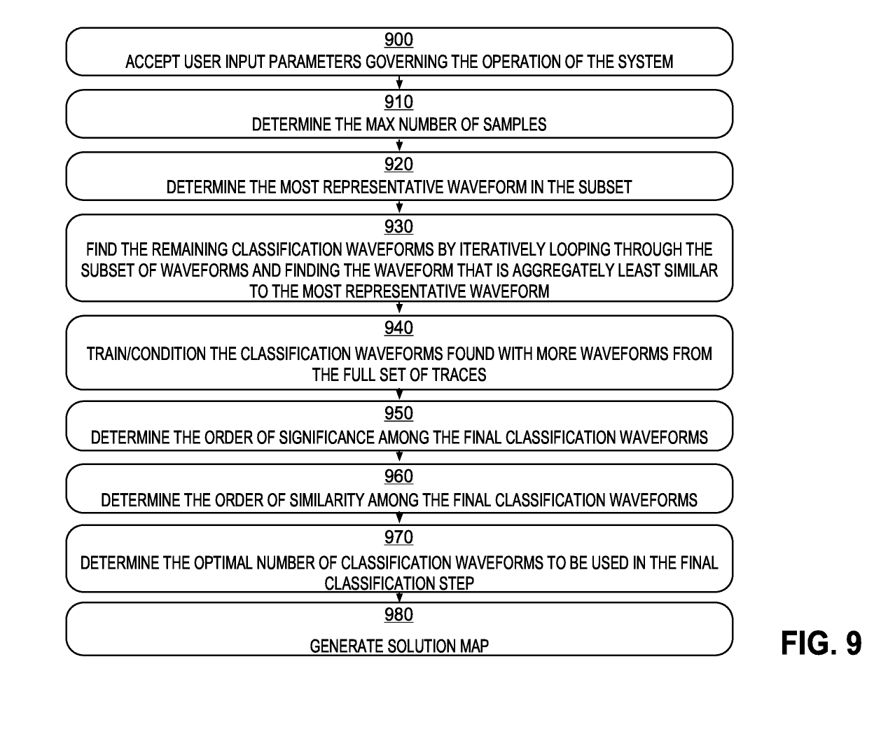

The general sequence of operations for the system and method have been broken up into a number of processes as shown in FIG. 9. In one implementation, the processes shown in FIG. 9 may be implemented on a computer system (standalone computer, terminal device, personal computer, laptop computer, tablet computer, server computer, etc.) in various computer programming languages on various computer operating systems with interactive graphical displays in which a memory of the computer system stores a plurality of lines of computer code and a processor of the computer system executes the plurality of lines of computer code to perform the processes shown in FIG. 9. Alternatively, the processes shown in FIG. 9 may be implemented in hardware, such as programmable logic devices, a memory, etc.

In a first process of the method, user input parameter governing the system operation are received (900.) For example, the parameters may include:

1) a maximum number of desired classification waveforms;

2) an analysis window that defines the trace waveform at each trace location, which may be a constant time or depth or may be variably defined by a single interpreted horizon or by two bounding interpreted horizons;

3) a statistical measure that defines “similarity” to be used in waveform to waveform comparisons. Examples of commonly used measures include the L1 norm (sum of absolute-value differences) and L2 norm (sum of squared differences);

4) a “domain” in which the statistical comparison will be made. The most common domain uses waveform sample amplitudes, although attributes such as peak frequencies from time-frequency domain are also useful. Complex waveform attributes such as magnitude, instantaneous phase, and instantaneous frequency may also be collectively used.

5) a number of traces to be used in the initial search for the classification waveforms. For 3D seismic volumes, this number may be defined by inline and crossline increments for a coarser grid than defined by the full volume. For 2D seismic lines, this number may be defined by a trace increment. It may also be defined by a random walk through either the 3D volume or through a collection of 2D lines.

The method may then determine the maximum number of samples for the waveforms (910) as found from the subset trace windowing controlled by the parameters specified above.

Process 920

The method may then find the most representative waveform to all other waveforms in the subset (920). This may be done by statistically comparing (using the statistical measure specified above) each waveform with all the other waveforms and selecting the waveform with the largest aggregate measure which becomes the first classification waveform. Computationally, this is the most intensive step in the full sequence of operations.

For example, process 920 may be performed using the following pseudocode:

Variable Definitions:
NSmax - the maximum number of samples in the subset waveform

traces to be used for interpolation for statistical comparisons

NClass - maximum number of classification waveforms
Start

Most representative trace is not set
Loop over all other traces in the subset (reference)

Interpolate trace to maximum number of samples NSmax
Set the aggregate similarity measure for this reference
trace to 0
Loop over all other traces in the subset (current)

Interpolate this trace to maximum number of samples
NSmax
Compute similarity measure between reference trace
and current trace
Aggregate this similarity measure

End of loop
If the most representative trace has not been set

Most representative trace is this reference trace
Highest similarity measure found is the aggregate

measure for this reference trace

Else, if the aggregate measure for this reference trace

is higher than previously found

Most representative trace is this reference trace
Highest similarity measure found is the aggregate

measure for this reference trace

End of loop

Process 930

Once the most representative waveform/trace has been identified, the method may find the remaining classification waveforms by iteratively looping through the subset of waveforms and finding the waveform that is aggregately least similar (again using the similarity measure specified) from the classification waveforms previously found (930). As each such waveform is found, it is added to the list of classification waveforms until the maximum specified number is attained.

For example, process 930 may be performed using the following pseudocode:

Variable Definitions:
NSmax - the maximum number of samples in the subset

waveform traces to be used for interpolation for statistical comparisons

NClass - maximum number of classification waveforms
Start

Loop over the remaining number of representative traces
to be found

Candidate trace is not set
Loop over all traces in the subset (reference)

If the reference trace is not contained in the list

of representative traces already found

Interpolate this trace to the maximum
number of samples NSmax
Set the aggregate similarity measure for
this reference trace to 0
Loop over previously found representative
traces (current)

Compute the similarity measure

between reference trace and current trace

Aggregate this similarity measure

End of loop
If the candidate trace has not been set

Candidate trace is set to this
reference trace
Least similarity measure found is

the aggregate measure for this reference trace

Else, if this aggregate measure for

this reference trace is lower than previously found

Candidate trace is set to this
reference trace
Least similarity measure found

is the aggregate measure for this reference trace

End of loop
Add the candidate trace to the list of representative
traces

End of loop

Process 940

Once the waveforms are identified, the classification waveforms may be trained/conditioned (940). For example, because a subset of the traces were used in processes 920 and 930 above, the method may optionally “train” or condition the classification waveforms found with more waveforms from the full set of traces. Any number of “training” algorithms may be used, but the Kohonen self-organizing map is suggested. This approach randomly selects waveforms from the full set and updates the classification waveforms. The amount of conditioning is based upon a weighting scheme, where weight is a function of the similarity measure found between the random trace waveform and each classification waveform (i.e., the more similarity the more weight assigned). The weight is further scaled as the training proceeds (i.e., earlier traces in the random walk have more weight than later ones).

For example, process 940 may be performed using the following pseudocode:

Define the number of traces in the training set and set a random walk
ordering
Loop through the traces in the training set (current)

Interpolate the current trace to the maximum number of samples
NSmax
Compute the similarity measure between current trace and each

representative trace

Update each representative trace with the current trace using a
weighting scheme

The weight is a function of the similarity measure found
between the current

trace and the representative trace (i.e., the more similarity the more
weight assigned).
The weight is further scaled as the training proceeds (i.e., earlier
traces in the training set have more weight than later ones).
End of loop
Final “trained” representative traces are the classification
waveforms

Process 950

The method may then determine the order of significance among the final classification waveforms (950). This may be accomplished by finding the classification waveform that is aggregately least similar to all the other classification waveforms. This is most commonly the waveform derived from the one found in process 920, and this waveform is deemed the most significant. The next most significant classification waveform is the one least similar to the most significant one. Now that the first two significant waveforms have been identified, the remainder of the classification waveforms needs to be ordered. A cluster similarity index is used to determine this ordering. Many such indices exist in the literature, but the Cluster Separation Index (CSI) is recommended. For example, the Davies-Bouldin, Bezdek, Dunn, Xie-Beni, Gath-Geva, etc, indices may also be used.

It is defined as the ratio of the minimum distance among the clusters (or in this case, waveforms) to the maximum distance among the clusters (i.e., the distance between the first two most significant waveforms). The third significant waveform is the one that produces the smallest CSI when combined with the first two significant waveforms. The fourth significant is the one that produces the smallest CSI with the first three significant waveforms, and so on. A plot of final CSI values versus waveform index is useful for interpreting significance (example in FIG. 4) as well as plotting the waveforms in order of significance (for example as shown in FIG. 6).

For example, process 950 may be performed using the following pseudocode:

First find the least similar classification waveform (Waveform 1) to

all the other classification waveform

Waveform 1 is not set
Loop over all classification waveforms (reference)

Set the aggregate similarity measure for this reference
waveform to 0
Loop over all other classification waveforms (current)

Compute similarity measure between reference

waveform and current waveform

Aggregate this similarity measure

End of loop
If Waveform 1 has not been set

Waveform 1 is this reference waveform
Least similarity measure found is the aggregate

measure for this reference waveform

Else, if the aggregate measure for this reference

waveform is lower than previously found

Waveform 1 is this reference waveform
Highest similarity measure found is the aggregate

measure for this reference trace

End of loop

Next find the waveform least similar (Waveform 2) to Waveform 1

Waveform 2 is not set
Loop over all classification waveforms (reference) that are not
Waveform 1

Compute the similarity measure for this reference
waveform to Waveform 1
If Waveform 2 is not set

Waveform 2 is this reference waveform
Set the least similarity measure to the similarity
measure computed

Else, if the similarity measure computed is lower than

the least similarity measure previously found

Waveform 2 is this reference waveform
Set the least similarity measure to the similarity
measure computed

End of loop

Order the remaining classification waveforms using Cluster
Separation Index (CSI)

Loop until all remaining classification waveforms have been
assigned

Next waveform to be assigned is not set
Loop over all classification waveforms yet to be
assigned (reference)

Compute CSI for this reference waveform combined

with all previously assigned waveforms

If the next waveform to be assign is not set

Next waveform to be assigned is this
reference waveform
Set the least found CSI to the CSI computed

using this reference waveform

Else, if the CSI computed using this reference

waveform is lower than the least found CSI

Next waveform to be assign is this reference
waveform
Set the least found CSI to the CSI computed

using this reference waveform

End of loop
Assign the next waveform found to the ordered list

End of loop

Process 960

The method may then determine the order of similarity among the final classification waveforms (960). The end waveforms in this ordered list are the first two significant waveforms found in process 950 above. By definition, they are the two least most similar classification waveforms. Then iteratively find the ordering of the remaining waveforms. Determine the waveform aggregately least similar to the waveforms not yet assigned to the ordering. Then determine the insertion position in the list. This is found by finding the index between the two waveforms to which the waveform to be inserted is most similar. The ordering is complete when all classification waveforms have been assigned. Plotting the waveforms in order of similarity is useful for determining variation and graduation in waveform response (example in FIG. 5).

For example, process 960 may be performed using the following pseudocode:

The first waveform in the order is the Waveform 1 found process
950.
The last waveform in the order is the Waveform 2 found in process
950.
Loop until all remaining waveforms have been assigned

Candidate waveform is not set
Loop through all unassigned waveforms (reference)

Loop through all assigned waveforms (current)
Compute similarity measure between reference

waveform and current waveform

Aggregate this similarity measure

End of loop
If the candidate waveform is not set

Candidate waveform is the reference waveform
Least similarity is the aggregate similarity for
the reference waveform

Else, if the aggregate measure for the reference

waveform is smaller than the least similarity

Candidate waveform is the reference waveform
Least similarity is the aggregate similarity for
the reference waveform

Index between adjacent waveforms is not set
Loop through each pair of adjacent waveforms in the

assigned list (current pair)

Compute aggregate similarity measure between each

pair and the candidate waveform

If the index is not set

Index is between the current pair
Most similarity is the aggregate measure

between current pair and the candidate waveform

Else, if the aggregate measure for the candidate

waveform is larger than the most similarity

Index is between the current pair
Most similarity is the aggregate measure

between current pair and the candidate waveform

End of loop
Assign the candidate waveform into the index position

of the assigned waveforms

End of loop

End of loop

Processes 970 and 980

The method may then determine the optimal number of classification waveforms to be used in the final classification step (970). This determination may be based upon investigating the variation and detail within the solution maps generated from selecting the number of classification waveforms and color rendered based either on significance or similarity (examples in FIGS. 7 and 8). The solution map is computed by looping through every seismic trace, extracting its waveform over the specified window, and then comparing that waveform to each classification waveform. The index of the classification waveform that is most similar to the trace waveform is assigned to that trace location. The index is determined by the ordering index of the classification waveform within either the significance ordering or the similarity ordering (980.) The map may then be displayed using a color scheme for the classification waveform indices. A classification volume may also be generated using the appropriate classification index corresponding to each of the trace waveform samples.

For example, process 980 may be performed using the following pseudocode:

Loop over all seismic traces in the full set (current)

Classification index is not set
Loop over all classification waveforms

Compute similarity measure between current trace

waveform and classification waveform

If the index is not set

Index is that for the classification waveform
Most similarity is the measure between current trace

waveform and classification waveform

Else, if the measure for the current trace waveform is

larger than the most similarity

Index is that for the classification waveform
Most similarity is the measure between current trace

waveform and classification waveform

End of loop
Assign index to the current trace

End of loop

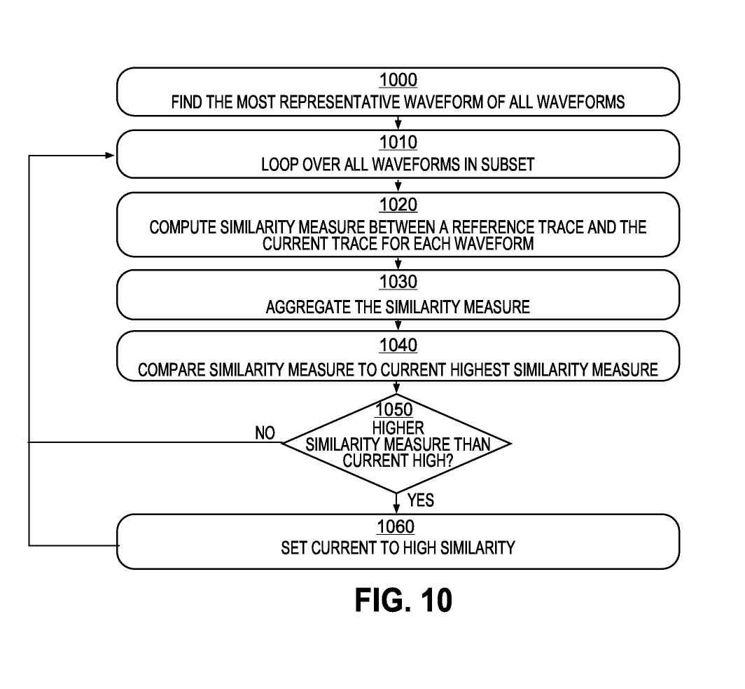

FIG. 10 illustrates an implementation of a method 1000 of selecting a most similar waveform out of a subset of all of the waveforms which is an example of process 920 shown in FIG. 9. In the process, the method loops over all waveforms in a set (1010) and then computes a similarity measure between a reference trace and the current trace for each waveform (1020.) The method may then aggregate the similarity measure (1030) and may compare the similarity measure to a current highest similarity measure (1040.) The method may then determine if the current waveform has a higher similarity measure that the current highest similarity measure (1050) and loops back to process 1010 if the similarity measure of the current waveform is not higher that the current highest similarity measure. If the current waveform similarity measure is the highest, then the method sets the current similarity measure to the highest similarity measure (1060.)

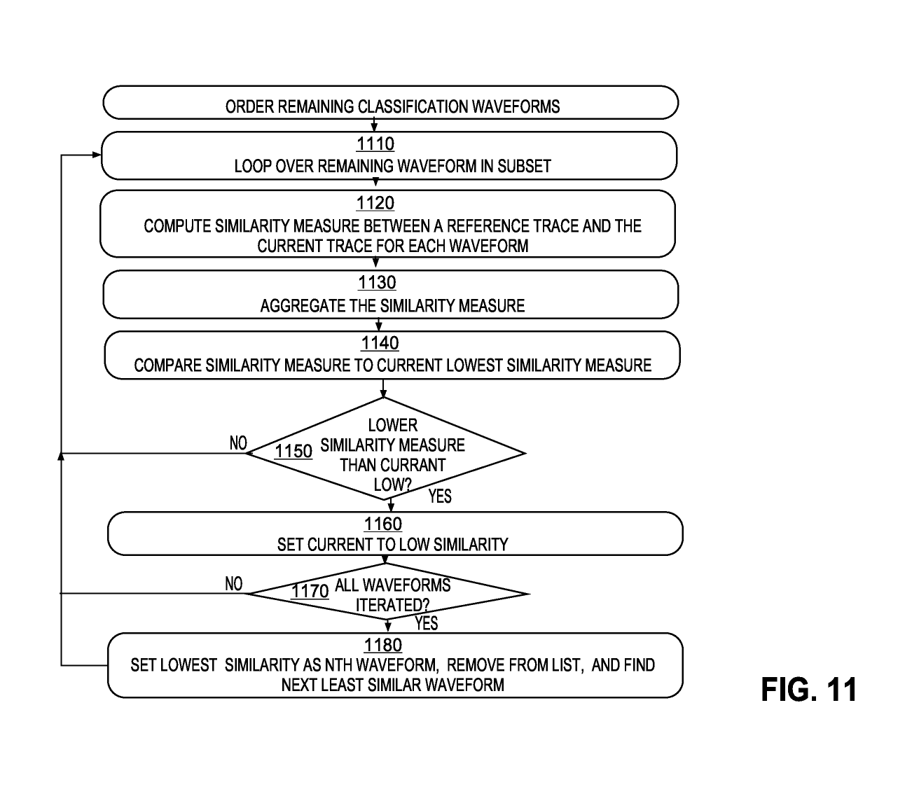

FIG. 11 illustrates an implementation of a method 1000 of classifying remaining subset of waveforms that are not the most similar waveform which is an example of process 930 shown in FIG. 9. In the process, the method loops over the remaining waveforms in the set (1110) and computes a similarity measure between a reference trace and a current trace for each waveform (1120.) The method may then aggregate the similarity measure (1130) and may compare the similarity measure to a current lowest similarity measure (1140.) The method may then determine if the current waveform has a lower similarity measure that the current lowest similarity measure (1150) and loops back to process 1110 if the similarity measure of the current waveform is not lower that the current lowest similarity measure. If the current waveform similarity measure is the lowest, then the method sets the current similarity measure to the lowest similarity measure (1160.) The method may then determine if each of the waveforms has been interated through (1170) and loops back to process 1110 if all of the waveforms have not been iterated. If all of the waveforms have been iterated, then the method sets the waveform with the lowest similarity as the Nth waveform, removes the waveform from the list and finds a next least similar waveform (1180.)

System Implementations

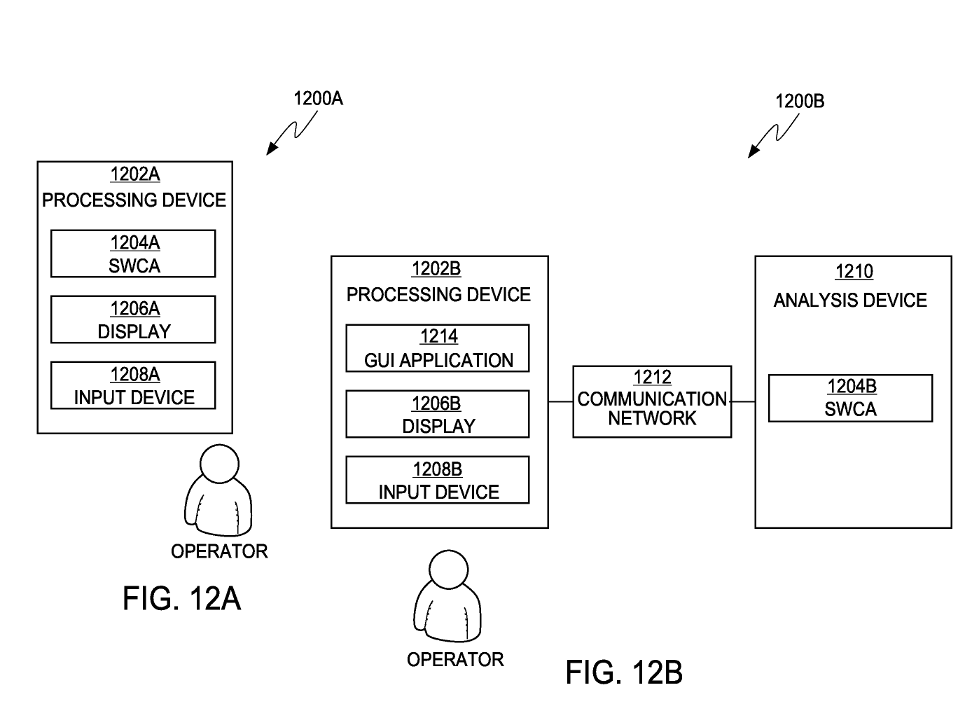

FIGS. 12A and 12B depict exemplary seismic waveform classification system (SWCS) 1200A and 1200B, respectively, in accordance with aspects of the disclosure. As shown in FIG. 12A, a SWCS 1200A includes a processing device 1202 that includes a waveform classification application (SWCA) 1204. An operator may perform the waveform classification by using the processing device 1202. The waveform classification may be performed on behalf of a client of the operator; an organization associated with the operator, or may be performed otherwise. The operator may use the processing device 1202 as a stand-alone device to perform waveform classification analysis. For example, processing device 1202 may be personal computer, a laptop, or some other stand alone computing device with one or more processors and memory that executes modules or instructions within the SWCA 1204 to analyze and/or classify seismic waveforms and generate one or maps, such as described above, for display to the operator. The processing device 1202A includes a display 1206A such as a computer monitor, for displaying data and/or graphical user interfaces. The processing device 1202A may also include an input device 1208A, such as a keyboard or a pointing device (e.g., a mouse, trackball, pen, or touch screen) to enter data into or interact with graphical user interfaces.

In some implementations, each of the processes shown in FIG. 9 may be instantiated by a component that is part of the seismic waveform classification system and each component may be implemented in hardware or software. Thus, the system may have a most representative waveform component, an additional waveform component, a training component, etc.

According to another aspect, as depicted in FIG. 12B, the operator may use the processing device 1202B in combination with an analysis device 1210 available over a network 1212. The processing device 1202B may be in a client-server relationship with the analysis device 1210, a peer-to-peer relationship with the analysis device 1210, or in a different type of relationship with the analysis device 1210. In one embodiment, the client-service relationship may include a thin client on the processing device 1202B. In another embodiment, client-service relationship may include a thick client on the processing device 1202B. In this aspect, the an analysis device 1210 may be, for example, a server computing device with or more processors and memory that executes modules or instructions within the SWCA 1204B to analyze and/or classify seismic waveforms and generate one or maps, such as described above, for display to the operator.

The processing device 1202B may also include a graphical user interface (or GUI) application 1214, such as a browser application, to generate a graphical user interface not (shown) on the display 1206B. The graphical user interface enables a user of the processing device 1202B to view seismic trace data, and/or map data. The graphical user interface 120 also enables a user of the processing device 1202B to interact with various data entry forms to view and modify settings data or preferences data (e.g., number of waveforms to be classified).

The analysis device 1206 is configured to receive data from and/or transmit data to one or more processing device 1202 through the communication network 1208. Although the analysis device 1206 is depicted as including an analysis device 1206, it is contemplated that the SWCS 1201 may include multiple analysis devices 1206 (e.g. multiple servers) in, for example, a cloud computing configuration. The communication network 1208 can be the Internet, an intranet, or another wired or wireless communication network. For example, communication network 1208 may include a Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A seismic data waveform classification method, comprising:
receiving a set of seismic waveforms;
determining, using a computer system, a most representative waveform in the set of seismic waveforms;
finding, using the computer system, one or more additional classification waveforms in the set of seismic waveforms, wherein each additional classification waveform is aggregately least similar to the most representative waveform; and
generating a solution map based on the most representative waveform and the one or more additional classification waveforms.

2. The method of claim 1, wherein finding the one or more additional classification waveforms further comprises iteratively looping through the set of seismic waveforms to identify the one or more additional classification waveforms.

3. The method of claim 1 further comprising training the most representative waveform and the one or more additional classification waveforms to generate a set of final classification waveforms and generating the solution map using the set of final classification waveforms.

4. The method of claim 3 further comprising determining an order of significance among the set of final classification waveforms before generating the solution map.

5. The method of claim 3 further comprising determining an order of similarity of the set of final classification waveforms before generating the solution map.

6. The method of claim 1 further comprising accepting a set of parameters to control the determining the most representative waveform and finding the one or more additional classification waveforms.

7. The method of claim 4, wherein determining an order of significance among the set of final classification waveforms further comprising determining an order of significance among the set of final classification waveforms using a cluster similarity index.

8. The method of claim 7, wherein the cluster similarity index is one of a cluster separation index, Davies-Bouldin index, a Bezdek index, a Dunn index, a Xie-Beni index and a Gath-Geva index.

9. A seismic data waveform classification system, comprising:
a computer having a processor;
a seismic waveform classification system executed by the processor; and
the seismic waveform classification system receives a set of seismic waveforms and has a most representative waveform component that determines a most representative waveform in the set of seismic waveforms, an additional waveform component that finds one or more additional classification waveforms in the set of seismic waveforms, wherein each additional classification waveform is aggregately least similar to the most representative waveform, and a map component that generates a solution map based on the most representative waveform and the one or more additional classification waveforms.

10. The system of claim 9, wherein the additional waveform component iteratively loops through the set of seismic waveforms to identify the one or more additional classification waveforms.

11. The system of claim 9, wherein the seismic waveform classification system further comprising a training component that trains the most representative waveform and the one or more additional classification waveforms to generate a set of final classification waveforms.

12. The system of claim 11, wherein the map component generates the solution map using the set of final classification waveforms.

13. The system of claim 11, wherein the seismic waveform classification system determines an order of significance among the set of final classification waveforms before generating the solution map.

14. The system of claim 11, wherein the seismic waveform classification system determines an order of similarity of the set of final classification waveforms before generating the solution map.

15. The system of claim 9, wherein the seismic waveform classification system accepts a set of parameters to control the determining the most representative waveform and finding the one or more additional classification waveforms.

16. The system of claim 9, wherein the computer is one of a personal computer, a laptop computer and standalone computer system.

17. The system of claim 9, wherein the computer is a processing device that displays the solution map and an analysis device, connected over a communication path to the processing device, that has the most representative waveform component, the additional waveform component and the map component.

18. The system of claim 13, wherein the seismic waveform classification system determines an order of significance among the set of final classification waveforms using a cluster similarity index.

19. The system of claim 18, wherein the cluster similarity index is one of a cluster separation index, Davies-Bouldin index, a Bezdek index, a Dunn index, a Xie-Beni index and a Gath-Geva index.
